(19) United States
(12) Patent Application Publication
(10) Pub. No.: US 2023/0307683 A1
(43) Pub. Date: Sep. 28, 2023

(54) REDOX FLOW BATTERY WITH A MEASURING DEVICE

(71) Applicant: VOITH PATENT GMBH, Heidenhein (DE)

(72) Inventors: Thomas LÜTH, Freiburg (DE); Klaus KRÜGER, Hüttlingen (DE)

(21) Appl. No.: 18/018,632

(22) PCT Filed: Apr. 7, 2021
(86) PCT No.: PCT/EP2021/058989

§ 371 Date: Jan. 30, 2023

(30) Foreign Application Priority Data
Aug. 3, 2020 (DE) 10 2020 120 428.0

(51) Int. Cl. H01M 8/18; H01M 8/0432; H01M 8/04082; H01M 8/0438

(52) U.S. Cl. CPC H01M 8/188; H01M 8/04201; H01M 8/0432; H01M 8/04425

(57) ABSTRACT

Redox flow battery including a cell assembly and a tank device for receiving electrolyte, the cell assembly including a plurality of cells, and the battery including at least one measuring device for determining an electrolyte property, including at least one measuring cell, the at least one measuring cell including at least one connection for supplying electrolyte, at least one connection for discharging electrolyte and a channel, which is connected to one of the electrolyte circuits in such a way that during a circulation of the electrolyte, the electrolyte flows through the channel, and the channel including a first section and a second section, the cross section of the first section being smaller than the cross section of the second section, and the connection for discharging electrolyte being connected to the first section by a connection line and the connection for supplying electrolyte being connected to the second section by a connection line.

The present invention relates to a redox flow battery including a measuring device for determining an electrolyte property. However, this does not involve, in particular, merely the determination of an electrode potential. The battery in this case may be operated alone or as part of a battery system. Such a battery system is made up, for example, of a series connection of multiple redox flow batteries (battery string).

### BACKGROUND INFORMATION

A redox flow battery includes a cell assembly, i.e., an arrangement of a plurality of redox flow cells, and a tank device for storing electrolyte including at least two tanks, a first tank storing negative electrolyte and a second tank storing positive electrolyte. During operation of the battery, negative and positive electrolyte is pumped in two separate circuits through the cells. Pump impellers, means for driving the pump impellers, and corresponding piping are provided for this purpose. To determine the state of charge (SoC), a redox flow battery includes a measuring device for determining the open circuit voltage (OCV). This is an electrochemical cell including chambers for positive and negative electrolytes, which are separated by a membrane. Electrodes, at which a voltage may be tapped as a measuring variable, are situated in the chambers. In addition, such a redox flow battery may also include further electrochemical cells, which are constructed similarly to the cells for determining the open circuit voltage. In the case of the further cells, however, one of the chambers is filled with a reference electrolyte, and the other chamber is filled with negative or positive electrolyte. Such cells are also referred to as reference cells and are used to detect a shift in the electrolyte of the battery. WO 2018/237181 A1 describes a redox flow battery including OCV cells and reference cells. WO 2012/020277 A1 describes a redox flow battery including an OCV cell, WO 2012/020277 A1 describing details for integrating the OCV cell into the battery.

### SUMMARY OF THE INVENTION

It is an object of the present invention to provide a redox flow battery that is more simply constructed or may be more flexibly designed than conventional redox flow batteries.

The present invention provides a redox-flow battery (1) including a cell assembly (2) and a tank device (3) for receiving electrolyte, the cell assembly (2) including a plurality of redox flow cells, and the tank device (3) including at least a first tank for receiving negative electrolytes, at least a second tank for receiving positive electrolytes, a pipe system for connecting the tanks to the cell assembly (2) and pump impellers (7) for conveying the electrolytes, in order to form in each case an electrolyte circuit, and the redox flow battery (1) including at least one measuring device (4) for determining an electrolyte property, including at least one measuring cell (4.1, 4.2, 4.3), the at least one measuring cell (4.1, 4.2, 4.3) including at least one connection for supplying electrolyte, at least one connection for discharging electrolyte and a connection element (5) including a channel (5.1), which is connected to one of the electrolyte circuits in such a way that during a circulation of the electrolyte in the electrolyte. The channel (5.1) includes a first section (5.1.1) and a second section (5.1.2), the cross section of the first section (5.1.1) being smaller than the cross section of the second section (5.1.2), and the connection for discharging electrolyte being connected to the first section (5.1.1) by a connection line and the connection for supplying electrolyte to the second section (5.1.2) being connected by a connection line.

### BRIEF DESCRIPTION OF THE DRAWINGS

The approaches according to the present invention are explained below with reference to figures. In particular:

FIG. 1 shows a redox flow battery

FIG. 2 shows measuring devices of a redox flow battery

FIG. 3 shows a measuring cell according to the present invention in a first specific embodiment

FIG. 4 shows a measuring cell according to the present invention in one further specific embodiment.

FIG. 5 shows a measuring cell according to the present invention in one further specific embodiment.

### DETAILED DESCRIPTION

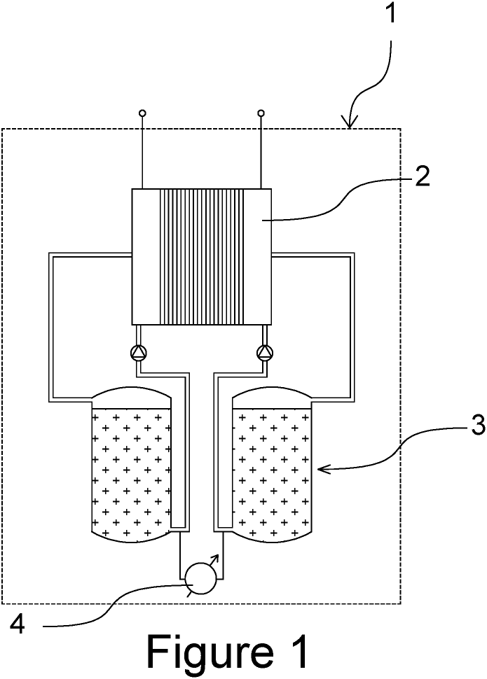

FIG. 1 shows a redox flow battery, which is identified with 1. The battery includes a cell assembly, which is identified with 2, and a tank device, which is identified with 3. Cell assembly 2 is an assembly of a plurality of redox flow cells, which may be arbitrarily arranged. For example, it could be a single cell stack, a series connection of multiple stacks, a parallel connection of multiple stacks or a combination of series connection and parallel connection of multiple stacks. Tank device 3 is used to store the electrolyte and for supplying cell assembly 2 with electrolyte. For this purpose, tank device 3 includes at least two tanks for negative and positive electrolyte, a pipe system for connecting the tanks to cell assembly 2 and pump impellers for conveying the electrolyte in order to form an electrolyte circuit in each case. Battery 1 further includes a measuring device for determining the so-called open circuit voltage (OCV), which is identified with 4. The OCV value is a measure of the state of charge (SoC) of the battery module. In general, battery 1 includes a measuring device 4 for determining an electrolyte property. FIG. 1 in this case shows the arrangement of the measuring device 4 within the battery in a purely schematic form.

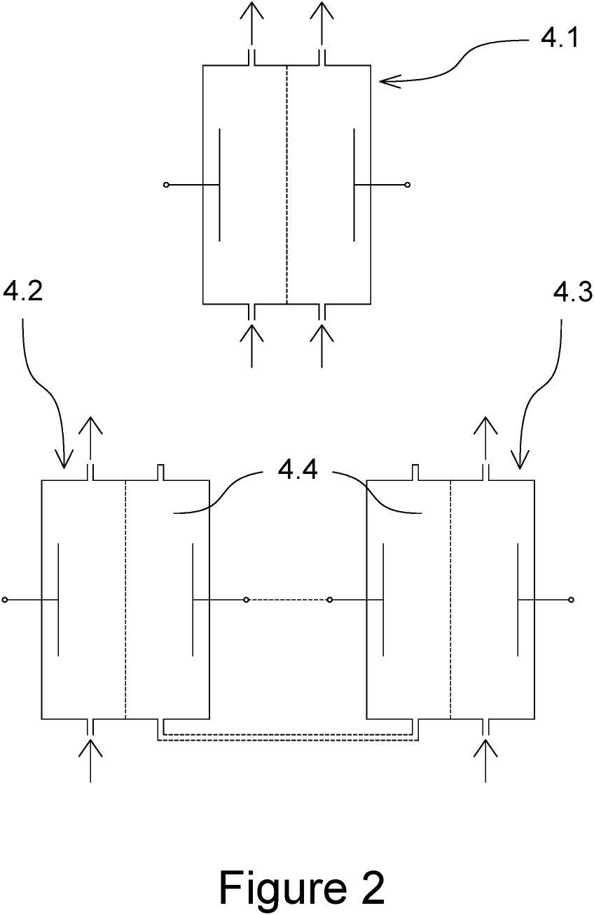

FIG. 2 shows two specific embodiments of such a measuring device 4. The specific embodiment represented in the upper part includes a measuring cell, which is identified with 4.1. Measuring cell 4.1 is divided by a membrane or a separator into two chambers. One electrode each is situated in each chamber. The open circuit voltage may be tapped between the electrodes. The measuring cell includes four connections, two connections each entering into each of the two chambers. One chamber is intended for receiving negative electrolyte, one connection being intended for the supply and one connection being intended for the discharge of negative electrolyte. The other chamber is intended for receiving positive electrolyte, one connection being intended for the supply and one connection being intended for the discharge of positive electrolyte. This is denoted by arrows in FIG. 2, which indicate the inflow and outflow of electrolyte.

The specific embodiment shown in the lower part of FIG. 2 includes two measuring cells, which are designed as reference cells and identified with 4.2 and 4.3. Each of the measuring cells is divided by a membrane or a separator into two chambers and one electrode each is situated in each chamber. For each of measuring cells 4.2 and 4.3, one chamber each is provided for receiving a reference liquid or a reference substance. The last-mentioned special case is discussed in detail further below. This means, the following passages relate to reference cells that include a reference liquid. However, this is not to be understood as being limited to a liquid. These chambers are identified with 4.4. Chambers 4.4 for receiving reference liquid may be closed, i.e., once the former have been filled with reference liquid, the connections shown in the figure may be sealed. Chambers 4.4 may also be connected to each other as is indicated below by the dashed line. Means may also be provided through which fresh reference liquid may be periodically introduced into chambers 4.4, the spent reference liquid being withdrawn from chambers 4.4. The two remaining chambers have two connections each, one of these chambers being intended for receiving negative electrolyte, and one connection being intended for the supply and one connection being intended for the discharge of negative electrolyte. The other chamber is intended for supplying positive electrolyte, one connection being intended for the supply and one connection being intended for the discharge of positive electrolyte. The electrodes of the chambers, which are intended for receiving the reference liquid may be connected to one another, as represented by a dashed line in FIG. 2, so that the open circuit voltage may be tapped directly between the remaining electrodes. Alternatively, the connection of the center electrodes shown may be omitted and one partial voltage each may be tapped between the two electrodes of each cell. The open circuit voltage then results from the sum of the two partial voltages. If the two partial voltages deviate from predefined reference values, the deviations may suggest the presence of a shift in the electrolyte of the battery. Such a shift may be caused by vanadium oxidation, further chemical secondary reactions as well as by the “crossover” at the membranes of the stacks. The possibility of detecting such a shift makes the specific embodiment represented below in FIG. 2 particularly advantageous.

“Crossover” may also occur in a reference cell itself. In order to reduce this undesirable effect, it is advantageous if the reference liquid has a preferably high viscosity. The reference liquid used may therefore advantageously be a so-called “gelled electrolyte,” which is described in WO 02/11227 A1. In general, V³⁺/V⁴⁺ electrolyte is used in vanadium-based redox flow batteries.

Instead of a conventional electrode and a reference liquid, one further specific embodiment of a reference cell involves using a platinum wire situated in the corresponding chamber, which is situated close to the membrane or to the separator and through which a current passes during the measurement. In addition to platinum, it is also possible to use silver-silver chloride as a material for such a wire.

One further specific embodiment of a reference cell is based on a completely different measuring principle. The reference cell in this case is made up of one single narrow chamber or one narrow space, through which electrolyte flows. The measurement of the electrolyte property then takes place not electrically with the aid of an electrode, but optically, by spectroscopic examination of the electrolyte film. Further details in this regard are found, for example, in “A review on the electrolyte imbalance in vanadium redox flow batteries” by Tossaporn Jirabovornwisut, Amornchai Arpornwichanop, published in the International Journal of Hydrogen Energy 44 (2019), pages 24485 through 24509 starting from the paragraph “U-vis spectroscopic measurement” on page 24497.

All specific embodiments have in common the fact that measuring device 4 for determining an electrolyte property includes at least one measuring cell and at least two connections, one connection for supplying electrolyte and one connection for discharging electrolyte being provided. In this case, it is clear that the connections are designed to supply the at least one measuring cell or the at least one chamber of the measuring cell with an electrolyte through-flow.

If measuring cell 4 includes only one measuring cell for determining the open circuit voltage, as represented in the upper part of FIG. 2, then this measuring cell is also referred to below as an OCV cell. Two reference cells together may form an OCV measuring device, as indicated in the lower part of FIG. 2.

In the specific embodiments represented in FIG. 2, a battery according to the present invention includes at least one measuring cell, the one measuring cell including a membrane and two chambers, and at least one chamber being provided for receiving electrolyte, and the measuring cell including at least one connection for supplying electrolyte and at least one connection for discharging electrolyte.

In order for a measuring device 4 to be able to reliably determine the instantaneous electrolyte property, the chamber must or the chambers must be supplied with fresh electrolyte. This occurs by integrating the measuring device into the electrolyte circuit. In conventional batteries, the connections for supplying and discharging electrolyte are connected to points of the electrolyte circuit, which have such a pressure difference that electrolyte is able to flow through the chambers of measuring device 4. Suitable branch points with high pressure are found in the lines that extend from the pressure side of the pump impellers up to the cell assembly. Suitable branch points with low pressure are found in the lines that extend from the tanks up to the intake side of the pump impellers or from the cell assembly up to the tanks. Low pressure further prevails in the upper part of the tank itself so that the connection for discharging electrolyte of measuring device 4 may also be connected to this part of the tank. In conventional batteries, the latter option is generally used. It is clear from the aforementioned that in conventional batteries, several lines and branching parts are required for supplying the measuring cells with electrolyte, which makes the battery complex and which therefore increases the risk of an electrolyte leakage.

An object of the inventors is therefore to design the connection of the measuring device to the electrolyte circuit in such a way that the aforementioned disadvantages are avoided.

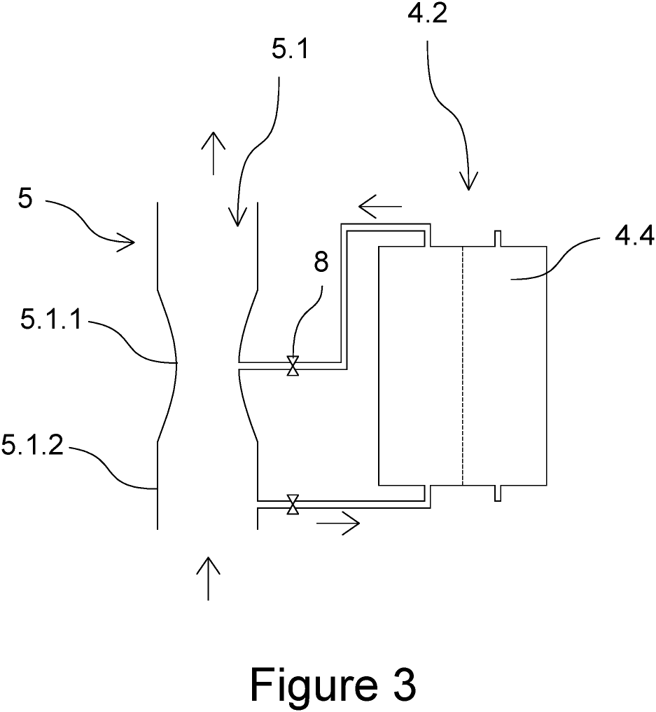

FIG. 3 shows in a schematic representation the basic structure of a measuring device according to the present invention as exemplified by a reference cell 4.2 including a closed reference chamber 4.4. In this case, the electrodes are not shown for the sake of clarity. In addition to reference cell 4.2, the measuring cell according to the present invention includes a connection element, which is identified with 5. Connection element 5 includes a channel, which is identified with 5.1. Channel 5.1 includes a first section, which is identified with 5.1.1 and a second section, which is identified with 5.1.2. The cross section of first section 5.1.1 in this case is smaller than the cross section of second section 5.1.2. The connection for discharging electrolyte of reference cell 4.2 is connected to first section 5.1.1. The connection for supplying electrolyte of reference cell 4.2 is connected to second section 5.1.2. Connection element 5 is connected to the electrolyte circuit in such a way that during a circulation of electrolyte in the electrolyte circuit, electrolyte flows through channel 5.1. In FIG. 3, this electrolyte flow is indicated by the vertical arrows. Due to the Bernoulli effect, a pressure occurs as a result in first section 5.1.1 which is lower than the pressure that is present in second section 5.1.2. This results in an electrolyte flow through the left chamber of reference cell 4.2, which is indicated by the horizontal arrows. The arrangement according to the present invention enables an integration of the measuring cell at an arbitrary point of the electrolyte circuit, since the arrangement itself generates the pressure gradient necessary for the flow of electrolyte through the corresponding chamber of the measuring cell. It should also be noted that the flow direction through the chamber is independent of the flow direction in channel 5.1, i.e., with respect to FIG. 3, that when reversing the vertical arrows, the direction of the horizontal arrows remains the same.

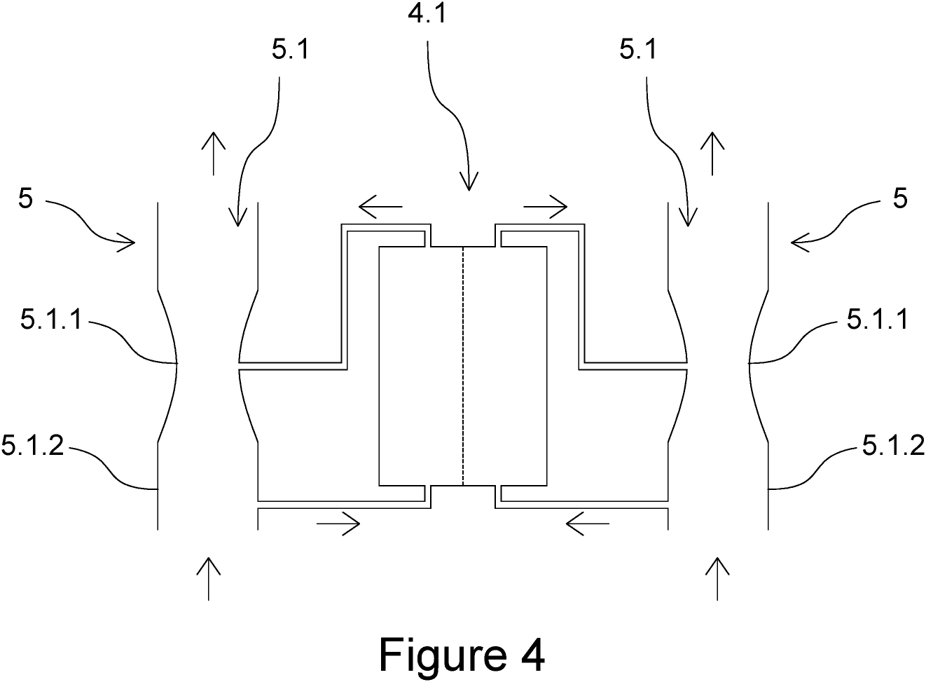

FIG. 4 shows in a schematic representation the basic structure of a measuring device according to the present invention as exemplified by an OCV cell 4.1. Since electrolyte must flow through both chambers of the OCV cell, the measuring cell according to the present invention according to FIG. 4 includes a further connection element 5, which is constructed, situated and connected to the right chamber of OCV cell 4.1, similar to connection element 5 described in FIG. 3.

One or multiple or all connection lines between the chambers and the first and second sections 5.1.1 and 5.1.2 of channel 5.1 may optionally include cutoff valves. FIG. 3 shows such cutoff valves, one of which is identified with 8. With the aid of these valves, it is possible to prevent the flow of electrolyte through the corresponding chambers. This may be advantageous in order to allow a flow of electrolyte through the chambers only when measured values are required by the relevant measuring cell. In this way, the “crossover” in the reference cell may be minimized.

A battery according to the present invention may include the following combination of measuring cells:
a reference cell
an OCV cell
an OCV cell and a reference cell
two reference cells, which form an OCV measuring device
an OCV cell and two reference cells.

Further measuring cells may be added, which are redundantly designed. In each case, the advantage according to the present invention occurs already when only one of the reference cells according to FIG. 3 is present, or when only one of the of the sides of a present OCV cell according to FIG. 4 is constructed. The advantage according to the present invention is naturally greatest when all present measuring cells are constructed according to FIGS. 3 or 4.

The contour of the constriction in channel 5.1 is represented in FIGS. 3 and 4 symmetrically in each case with respect to the narrowest side. This contour may also extend asymmetrically, for example, in that viewed in the flow direction of the electrolyte, the channel narrows in a section which is shorter than the section in which the channel expands again after the narrowest point. If this so-called calming section after the narrowest point of the channel is selected long enough, the pressure loss caused by the constriction may then be kept very low, so that the losses associated therewith also become very minimal.

It is particularly advantageous if the respective measuring cells constructed according to the present invention together with connection element or connection elements form a structural unit, so that the chambers, the membrane or the membranes, the channel or the channels and the connection lines between the chambers and the channels are embedded into this one structural unit. This structural unit may, for example, be manufactured by injection molding, the structural unit preferably being made of a plastic. As a further manufacturing option, the aforementioned structural unit includes two or multiple components made of plastic, in which the chambers, channels and connection lines are embedded with the aid of corresponding recesses. The chambers, channels and connection lines are then formed by joining the components. The recesses may be formed, for example, by milling. The joining in this case may also take place by screwing together, gluing or welding. When screwing together, seals are to be provided if necessary. The multipart arrangement may be particularly advantageously designed if the one chamber of the measuring cell is provided in one of the components, and the other chamber of the measuring cell is provided in another component in such a way that the membrane is clamped between these two components. If necessary, seals are to be provided at the clamping point. Alternatively, the structural unit may also be manufactured via an additive manufacturing method. The aforementioned manufacturing methods may of course also be combined, for example, by manufacturing a portion of the components using casting techniques, and by producing another portion of the components by milling.

Sensors may be advantageously integrated into the structural unit. These may involve, for example, pressure sensors or temperature sensors. Temperature sensors are of particular importance, since the temperature has a significant influence on the potential ascertained from the Nernst equation.

To connect the connection element or the connection elements at the electrolyte circuit, flanges or connection pieces may be provided. These may be advantageously integrated into the structural unit.

One further advantageous specific embodiment results when the arrangement made up of connection lines together with OCV cell is designed to be self-venting. For example, the connection lines may be designed to be monotonically ascending in the flow direction of the electrolyte and/or using suitable geometries of the OCV cell. This facilitates the automatic venting of the measuring cells.

One particularly advantageous specific embodiment results when, in addition to the channel, the chambers and the supply lines, one or both of the pump impellers of the battery are also integrated into the structural unit. Further connection pieces in the electrolyte circuit are eliminated as a result, so that the complexity and the susceptibility to leakage may be further reduced. In this case, the channel may be provided with a narrowing either on the pressure side or on the intake side of the pump impeller. In this specific embodiment, the structural unit represents essentially an enlarged pump head, in which the measuring cell, the connection element or the connection elements and the connection lines are integrated. With respect to the manufacture of this specific embodiment, the above applies.

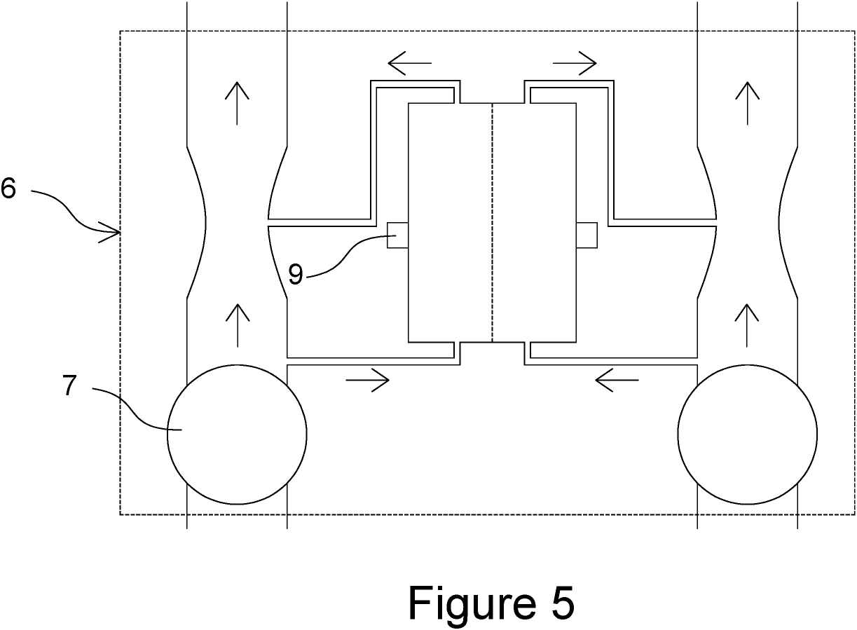

FIG. 5 shows such a specific embodiment in a schematic representation, the dashed rectangle, which is identified with 6, representing the structural unit. The pump impellers are indicated by the circles, one of which is identified with 7. The pump impellers may be advantageously designed in such a way that they may be driven by a shared motor. FIG. 5 also shows two temperature sensors integrated into structural unit 6, one of which is identified with 9. Temperature sensors 9 are advantageously situated in such a way that they have a good thermal contact to the electrolytes located in the measuring cell. This is, for example, the case when the sensors are situated in such a way that they are located in the direct vicinity of the electrical supply lines, which lead into the measuring cell.

List of reference numerals

| | |
|---|---|
| 1 | Redox flow battery |
| 2 | Cell assembly |
| 3 | Tank device |
| 4 | Measuring device for determining an electrolyte property |
| 4.1 | Measuring cell / OCV cell |
| 4.2 | Measuring cell / reference cell |
| 4.3 | Measuring cell / reference cell |
| 4.4 | Reference liquid |
| 5 | Connection element |
| 5.1 | Channel |
| 5.1.1 | First section of the channel |
| 5.1.2 | Second section of the channel |
| 6 | Structural unit |
| 7 | Pump impeller |
| 8 | Cutoff valve |
| 9 | Temperature sensor |

What is claimed is:

1-12. (canceled)

13. A redox-flow battery comprising:
a cell assembly;
a tank device for receiving electrolyte, the cell assembly including a plurality of redox flow cells, and the tank device including at least a first tank for receiving negative electrolytes, at least a second tank for receiving positive electrolytes, a pipe system for connecting the tanks to the cell assembly and pump impellers for conveying the electrolytes, in order to form in each case an electrolyte circuit; and
at least one measuring device for determining an electrolyte property, including at least one measuring cell, the at least one measuring cell including at least one connection for supplying electrolyte, at least one connection for discharging electrolyte and a connection element including a channel connected to one of the electrolyte circuits in such a way that during a circulation of the electrolyte in the electrolyte circuit, electrolyte flows through the channel, the channel including a first section and a second section, the cross section of the first section being smaller than the cross section of the second section, and the connection for discharging electrolyte being connected to the first section by a connection line and the connection for supplying electrolyte to the second section being connected by a further connection line.

14. The redox flow battery as recited in claim 13 wherein the at least one measuring cell is designed as a reference cell.

15. The redox flow battery as recited in claim 13 wherein the at least one measuring cell is designed as an OCV cell.

16. The redox flow battery as recited in claim 14 wherein the reference cell includes two chambers, and one of the chambers is filled with a reference liquid, which is formed as gelled electrolyte.

17. The redox flow battery as recited in claim 14 wherein the reference cell includes two chambers, and a platinum wire is situated in one of the chambers.

18. The redox flow battery as recited in claim 14 wherein the determination of the electrolyte property takes place with the aid of an optical spectroscopic measurement.

19. The redox flow battery as recited in claim 13 further comprising a cutoff valve situated in the connection line or the further connection line.

20. The redox flow battery as recited in claim 13 wherein, when viewed in the flow direction of the electrolyte, the channel narrows in a section shorter than a further section, the channel expanding in the further.

21. The redox flow battery as recited in claim 13 wherein the connection line and further connection line are designed to be monotonically ascending in the flow direction of the electrolyte.

22. The redox flow battery as recited in claim 13 wherein the at least one measuring device is designed as a structural unit, so that the at least one measuring cell, the channel and the connection line and the further connection line between the at least one measuring cell and the channel are embedded into the structural unit.

23. The redox flow battery as recited in claim 22 further comprising at least one pump impeller embedded into the structural unit.

24. The redox flow battery as recited in claim 22 further comprising at least one temperature sensor embedded into the structural unit.
